(19) United States
(12) Patent Application Publication
(10) Pub. No.: US 2013/0305131 A1
(43) Pub. Date: Nov. 14, 2013

(54) METHOD, SYSTEM AND COMPUTER STORAGE MEDIUM FOR PRE-READING NETWORK DATA

(71) Applicant: TENCENT TECHNOLOGY (SHENZHEN) COMPANY LIMITED, Guangdong (CN)

(72) Inventor: Lei HUANG, Guangdong (CN)

(21) Appl. No.: 13/937,114

(22) Filed: Jul. 8, 2013

Related U.S. Application Data
(63) Continuation of application No. PCT/CN2012/070290, filed on Jan. 12, 2012.

(30) Foreign Application Priority Data
Jan. 18, 2011 (CN) CN 201110020228.3

(51) Int. Cl. G06F 17/22

(52) U.S. Cl. CPC G06F 17/2247
USPC 715/205

(57) ABSTRACT

A method, a system and a computer storage medium for pre-reading network data are disclosed. The method includes the following steps: acquiring a set of dynamic page-turning elements; acquiring a domain name of a browsed webpage, and searching the set of dynamic page-turning elements for corresponding page-turning elements based on the domain name; searching the browsed webpage for a webpage element with hyperlink matching the corresponding page-turning element based on the corresponding page-turning element; and pulling page data corresponding to the matched webpage element, and pre-reading. The set of dynamic page-turning elements includes the page-turning element required by users, and pre-reading is done based on the page-turning element, therefore the method, system and computer storage medium for pre-reading network data can improve the accuracy of the pre-read content, reducing the probability of sending unnecessary network data for a user to the user, and increasing utilization ratio of network resource.

### FIELD OF THE INVENTION

The present invention relates to the field of Internet technology, and in particular relates to a method, a system and a computer storage medium for pre-reading network data.

### BACKGROUND OF THE INVENTION

In recent years, with the rapid development of mobile Internet and the rapid popularization of 3G network and terminal equipments, the demand for putting traditional Internet data into mobile communication terminals is getting greater and greater. The user can browse Internet data through the browser installed in mobile communication terminals, such as phones. However, because the computation and storage capacity of the mobile communication terminal is weak, the network transmission capacity of mobile gateway is not strong, with limited resources to browse.

With regard to mobile communication terminals with small screen, Internet data is generally under a pagination conversion process by a transit server, such that the user will usually see partial pages after pagination when browsing a webpage in a mobile communication terminal. In order to browse the complete content of the webpage, one of the operations that the user usually does is to click an element like “Next page”. The operation of pre-reading network data of the relevant webpage before the user actually clicks on the “Next page” is called pre-reading. However, traditional intelligent pre-reading function is based on limited number of fixed page-turning elements, which is unable to be self-adaptive to different types of sites or to meet different needs of different users, but pre-reading unnecessary network data to the user, leading to waste of network resources.

### SUMMARY OF THE INVENTION

Based on the above, there is a need to provide a method for pre-reading network data which can increase utilization ratio of network resource.

A method for pre-reading network data, comprises the steps of acquiring a set of dynamic page-turning elements, acquiring a domain name of a browsed webpage, and searching the set of dynamic page-turning elements for a corresponding page-turning element based on the domain name, searching the browsed webpage for a webpage element with hyperlink matching the corresponding page-turning element based on the corresponding page-turning element, and pulling page data corresponding to the matched webpage element, and pre-reading.

Preferably, the method further comprises the step of acquiring a set of static page-turning elements; and after the step of searching the browsed webpage for the matching webpage element with hyperlink based on the corresponding page-turning element, determining whether the matching is successful: if yes, pulling page data corresponding to the matched webpage element after matching, and pre-reading; otherwise, searching the set of static page-turning elements for a second corresponding page-turning element based on the domain name, and searching the browsed webpage for a webpage element with hyperlink matching the second corresponding page-turning element based on the page-turning element in the set of searched static page-turning elements, then pulling page data corresponding to the matched webpage element with hyperlink, and pre-reading.

Preferably, the method further comprises the steps of acquiring weights of the page-turning elements corresponding to the domain name in the set of dynamic page-turning elements, searching the browsed webpage for the webpage element with hyperlink matching the page-turning element based on the descending order of weight values of the page-turning elements, and identifying the webpage element with hyperlink which is corresponding to the page-turning element having the largest weight after the page-turning element matches the webpage element.

Preferably, the step further comprises the step of acquiring a clicked webpage element with hyperlink, and updating the set of dynamic page-turning elements by adding the clicked webpage element with hyperlink clicked.

Preferably, the step of updating the set of dynamic page-turning elements by adding the clicked webpage element with hyperlink clicked specifically includes the steps of searching the set of dynamic page-turning elements for a list of page-turning elements corresponding to the domain name based on the domain name of the webpage which has the clicked webpage element with hyperlink, and determining whether the clicked webpage element with hyperlink is in the list of page-turning elements: if yes, adding 1 to the weight of the page-turning element; otherwise, adding the webpage element with hyperlink to the list of page-turning elements.

Preferably, the method further includes uploading a user identification number and the updated set of dynamic page-turning elements to a server, acquiring the user identification number, and downloading the set of dynamic page-turning elements from the server based on the user identification number.

Preferably, the step of acquiring the set of dynamic page-turning elements includes dynamically collecting the domain name of the webpage browsed by a user and webpage elements with hyperlink operated when browsing the webpage, and adding up the webpage elements to form a set of dynamic page-turning elements of the user.

In addition, there is also a need to provide a system for pre-reading network data that can increase utilization ratio of network resource.

A system for pre-reading network data, includes an information acquisition module, configured to acquire a set of dynamic page-turning elements; a searching module, configured to acquire a domain name of a browsed webpage, and to search the set of dynamic page-turning elements for a corresponding page-turning element based on the domain name; a matching module, configured to search the browsed webpage for a webpage element with hyperlink matching the corresponding page-turning element based on the corresponding page-turning element; and a webpage-pulling module, configured to pull page data corresponding to the matching webpage element, and to pre-read.

Preferably, the information acquisition module is also configured to acquire the set of static page-turning elements.

The system for pre-reading network data further includes a determining module, configured to determine whether the corresponding page-turning element in the set of dynamic page-turning elements matches the webpage element with hyperlink, wherein the webpage-pulling module is also configured to pull page data corresponding to the matching webpage element and to pre-read, after the page-turning element in the set of dynamic page-turning elements successfully matches the webpage element with hyperlink; wherein the searching module is also configured to search the set of static page-turning elements for a second corresponding page-turning element based on the domain name, when the page-turning elements in the set of dynamic page-turning elements do not match the webpage element with hyperlink, and wherein the matching module is also configured to search the browsed webpage for a webpage element with hyperlink matching the second corresponding page-turning element based on the second corresponding page-turning element in the set of searched static page-turning elements.

Preferably, the information acquisition module is also configured to acquire weights of the page-turning elements corresponding to the domain name in the set of dynamic page-turning elements, where the matching module is also configured to search the browsed webpage for the matching webpage element with hyperlink based on the descending order of the weight values of the page-turning elements, and to identify the webpage element with hyperlink corresponding to the page-turning element having the largest weight after the page-turning element matches the webpage element.

Preferably, the information acquisition module is also configured to acquire a webpage element with hyperlink which is clicked by a user.

The system further includes an updating module, configured to update the set of dynamic page-turning elements by adding the clicked webpage element with hyperlink.

Preferably, the updating module is also configured to search the list of dynamic page-turning elements for the list of page-turning elements corresponding to the domain name based on the domain name of the webpage which has the clicked webpage element with hyperlink, to determine whether the clicked webpage element with hyperlink is in the list of page-turning elements: if yes, adding 1 to the weight of the page-turning element; otherwise, adding the webpage element with hyperlink to the list of page-turning elements.

Preferably, the system further includes an uploading module, configured to upload a user identification number and the updated set of dynamic page-turning elements to a server, and wherein the information acquisition module is also configured to acquire the user identification number, and to download the set of dynamic page-turning elements from the server based on the user identification number.

Preferably, the information acquisition module is also configured to dynamically collect the domain name of the webpage browsed by a user and webpage elements with hyperlink operated when browsing the website, and adding up the webpage elements to form a set of dynamic page-turning elements of the user.

In addition, there is a need to provide a computer storage medium.

A non-transitory computer-readable storage medium for storing computer-executable instructions which, when executed by one or more computer processors, causes the one or more computer processors to pre-read network data, wherein the computer-executable instructions comprise instructions for acquiring a set of dynamic page-turning elements, acquiring a domain name of a browsed webpage, and searching the set of dynamic page-turning elements for a corresponding page-turning element based on the domain name, searching the browsed webpage for a webpage element with hyperlink matching the corresponding page-turning element based on the corresponding page-turning element, pulling page data corresponding to the matched webpage element, and pre-reading.

Preferably, the computer-executable instructions further comprises instructions for acquiring a set of static page-turning elements, and after the step of searching the browsed webpage for a matching webpage element with hyperlink based on the corresponding page-turning element: determining whether the matching is successful: if yes, pulling page data corresponding to the matched webpage element with hyperlink after matching, and pre-reading; otherwise, searching the set of static page-turning elements for a second corresponding page-turning element based on the domain name, and searching the browsed webpage for a webpage element with hyperlink matching the second corresponding page-turning element based on the page-turning element in the set of searched static page-turning elements, then pulling page data corresponding to the matched webpage element with hyperlink, and pre-reading.

Preferably, the computer-executable instructions further comprises instructions for acquiring weights of the page-turning elements corresponding to the domain name in the set of dynamic page-turning elements, and searching the browsed webpage for the webpage element with hyperlink matching the page-turning element based on descending order of weight values of the page-turning elements, and identifying the webpage element with hyperlink corresponding to the page-turning element having the largest weight after the page-turning element matches the webpage element.

Preferably, the computer-executable instructions further includes instructions for acquiring a webpage element with hyperlink clicked by a user, and updating the set of dynamic page-turning elements by adding the webpage element with hyperlink clicked by the user.

Preferably, the instructions for updating the set of dynamic page-turning elements by adding the webpage element with hyperlink clicked by the user include instructions for searching the dynamic list of page-turning elements for the list of page-turning elements corresponding to the domain name based on the domain name of the webpage which has the webpage element with hyperlink clicked by the user and determining whether the webpage element with hyperlink clicked by the user is in the list of page-turning elements: if yes, adding 1 to the weight of the page-turning element; otherwise, adding the webpage element with hyperlink to the list of page-turning elements.

Preferably, the instructions for acquiring the set of dynamic page-turning elements includes instructions for dynamically collecting the domain name of a webpage browsed by a user and webpage elements with hyperlink operated when browsing the website, and adding up the webpage elements to form a set of dynamic page-turning elements of the user.

By the above described method, system and computer storage medium for pre-reading network data, the set of dynamic page-turning elements is used to acquire the domain name of the browsed webpage, to search the set of dynamic page-turning elements for corresponding page-turning element, then to search the browsed webpage for matched webpage element with hyperlink based on the page-turning element and to pull the page data corresponding to the webpage element to pre-read. The set of dynamic page-turning elements includes the page-turning element required by users, therefore, pre-reading based on said page-turning element can improve the accuracy of the pre-read content, reducing the probability of sending unnecessary network data for a user to the user, and increasing utilization ratio of network resource.

### BRIEF DESCRIPTION OF THE DRAWINGS

FIG. 1 is the flow chart of the method for pre-reading network data in one embodiment;

FIG. 2 is the flow chart of the method for pre-reading network data in another embodiment;

FIG. 3 is the schematic structure chart of the system for pre-reading network data in one embodiment;

FIG. 4 is the schematic structure chart of the system for pre-reading network data in another embodiment.

### DETAILED DESCRIPTION OF THE PREFERRED EMBODIMENTS

The invention will be better understood with reference to the following description taken in conjunction with the specific embodiments and the accompanying drawings.

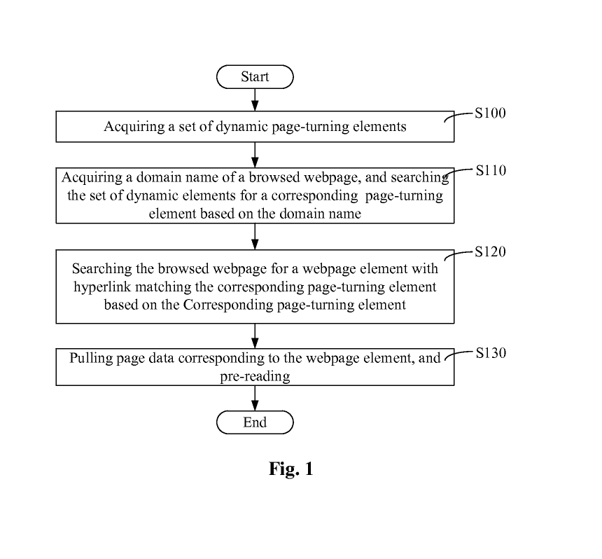

As shown in FIG. 1, a method for per-reading network data in one embodiment includes the steps of:
step S100: acquiring the set of dynamic page-turning elements.

The set of dynamic page-turning elements includes the domain name and page-turning elements corresponding to the domain name, etc. The page-turning element is the keyword for page turning, such as “Next page”, “Next chapter”, “Next”, or it may be a picture and so on. The data of the set of dynamic page-turning elements when initializing can be null; as the users continue browsing different web pages, the client collects corresponding page-turning elements clicked by the user to dynamically update the data of the set of dynamic page-turning elements, and upload the data to the server, keeping the set of dynamic page-turning elements of the client the same with that of the server.

In one embodiment, the step of acquiring the set of dynamic page-turning elements is: dynamically collecting the domain name of the webpage browsed by the user and the webpage element with hyperlink operated when browsing the website, and adding up to form a set of dynamic page-turning elements of the user. Collecting the domain name of the webpage browsed by the user and the webpage element with hyperlink operated when browsing the website refers to collecting the characteristics data of the user's operation behaviors when browsing the webpage, and acquiring the page-turning elements by analyzing the collected characteristics data of operation behaviors, which form the set of dynamic page-turning elements of the user. This set of dynamic page-turning elements of the user embodies the user's operation habits, and can meet the needs of the user more accurately. In addition, the set of dynamic page-turning elements can updates internal data in real time. The characteristics data of operation behaviors refers to the network data clicked by the user when browsing web pages. The webpage element with hyperlink refers to the node with a point to a Web address in the webpage, including text nodes, picture nodes etc., in which the text node can be expressed as “Next page”, “Next chapter”, etc., and the picture node can be expressed as a hand icon for page turning. After the webpage element with hyperlink is clicked, the page data of the Web address pointed by the hyperlink is pulled.

Web pages are classified according to their domain names, such as abc.com, def.net, etc. Different users browse different web pages using different operations, thus the webpage elements with hyperlink collected dynamically are also different. For example, user A pays attention to pictures, such that the collected webpage elements can be pictures, which are analyzed to acquire the picture page-turning elements and to form the set of dynamic page-turning elements of user A; similarly, user B pays attention to English webpage, such that the collected webpage elements may be “Next”, which forms the set of dynamic page-turning elements of user B.

In one embodiment, the Step S100 of acquiring the set of dynamic page-turning elements is: acquiring the user identification number, and downloading the set of dynamic page-turning elements from the server based on the user identification number. The corresponding set of dynamic page-turning elements can be saved in a server with user identification number as an index, and the saved sets of dynamic page-turning elements for different users will be different, which can meet the needs of different users.

Step S110: acquiring the domain name of the browsed webpage, and searching the set of dynamic page-turning elements for corresponding page-turning elements based on the domain name.

In Step S110, the domain name of the browsed webpage is acquired; because the set of dynamic page-turning elements contain the domain names and the page-turning elements corresponding to the domain names, it is possible to search for the page-turning elements corresponding to the domain name based on the domain name of webpage.

In one embodiment, in addition to acquiring the domain name of the browsed webpage, the method also include acquiring the weights of the page-turning elements corresponding to the domain name in the set of dynamic page-turning elements. In addition to the domain names and page-turning elements corresponding to domain names, the set of dynamic page-turning elements further includes the weights and time stamps of the page-turning elements. The page-turning elements can be expressed as “Next page”, “Next chapter”, “Next”, or can be pictures, etc. The weight of page-turning element can be the collected clicked times of the page-turning element. The time stamp is the time when the page-turning element last updates. The set of dynamic page-turning elements in one embodiment is shown in Table 1.

TABLE 1
Set of Dynamic Page-turning elements

| Domain Name | Keyword | Weight | Time-stamp |
|---|---|---|---|
| pic.abc.com | Next Picture | 8 | 1234556 |
| | Next One Picture | 3 | 2312317 |
| | . . . | . . . | . . . |
| book.abc.com | Next Chapter | 15 | 1231234 |
| | Next One Chapter | 3 | 1233335 |
| | . . . | . . . | . . . |
| news.abc.com | Next Page | 22 | 2313133 |
| | Next One Page | 5 | 1231233 |
| | . . . | . . . | . . . |
| . . . | . . . | . . . | . . . |

Step S120: searching the browsed webpage for the webpage element with hyperlink matching the page-turning element based on the page-turning element in the set of dynamic page-turning elements.

In one embodiment, the weights of the page-turning elements corresponding to the domain name in the set of dynamic page-turning elements are also acquired, thus the specific process of step S120 is: searching the browsed webpage for the webpage element with hyperlink matching the page-turning element based on descending order of weight values of the page-turning elements, and acquiring the webpage element with hyperlink corresponding to the page-turning element having the largest weight after the page-turning element matches the webpage element; after acquiring the weight of the page-turning elements corresponding to the domain name in the set of dynamic page-turning elements, searching the webpage for the webpage element with hyperlink to match, based on descending order of the weight values, with page-turning element having larger weight value to match first; then acquiring the webpage element with hyperlink corresponding to the page-turning element having the largest weight after the page-turning element successfully matches the webpage element. As shown in Table 1, if the domain name of the webpage is pic.abc.com, then search the webpage for the webpage element with hyperlink matching the page-turning element of “Next Picture”.

Step S130: pulling the page data corresponding to the webpage element, and pre-reading.

Webpage elements correspond to the link addresses of URL (Universal Resource Locator). After the current page has been pulled, analyzed, rendered and typeset, the background processing program in the client is started to pull the URL page data corresponding to the webpage element. The pre-reading operation refers to pre-reading webpage data of the next page pulled in the pulling operation, and analyzing, rendering and typesetting, before the user clicks to browse the next page.

Thus, when the user is browsing the current page, the process of pulling the webpage data pointed by the webpage element matching the page-turning element happens simultaneously. When the user clicks to browse the next page, the most time-consuming network interactive link can be eliminated; in addition, the matching is based on dynamic page-turning elements, which can reduce the probability of pre-reading unnecessary network data, thus increasing utilization ratio of network resource.

In one embodiment, the webpage element with hyperlink corresponding to the page-turning element having the largest weight is acquired, thus the specific process of step S130 is: pulling the webpage data of the webpage element corresponding to the matched page-turning element having the largest weight, and pre-reading; acquiring the webpage element corresponding to the matched page-turning element having the largest weight, and pre-reading the pulled webpage data corresponding to the webpage element.

In a preferred embodiment, the above pre-reading of network data further includes: acquiring the webpage element with hyperlink which is clicked by the user, and updating the set of dynamic page-turning elements by adding the webpage element with hyperlink clicked by the user.

Specifically, in one embodiment, the method further includes searching the set of dynamic page-turning elements for the list of page-turning elements corresponding to the domain name of the webpage which has the webpage element with hyperlink clicked by the user. The list of page-turning elements includes domain names, the page-turning elements, weights of the page-turning elements, etc.

Determine whether the webpage element with hyperlink clicked by the user is in the list of page-turning elements: if yes, then adding 1 to the weight of the page-turning element; otherwise, adding the webpage element with hyperlink to the list of page-turning elements. If the webpage element clicked by the user is in the list of page-turning elements, then add 1 to the weight of the corresponding page-turning element; for example, the webpage element of “Next Picture” can be found in Table 1, then the weight of the page-turning element of “Next Picture” is added by 1 and reaches 9. If the webpage element clicked by the user is not in the list of page-turning elements, then the webpage element is added to the list of page-turning elements, and its weight set to be 1; for example, the page-turning element of “Next” is added to Table 1, with its weight set to be 1. In this way, the set of dynamic page-turning elements is updated.

In a preferred embodiment, the method for pre-reading network data further comprises the step of uploading the user identification number and the updated set of dynamic page-turning elements to a server. Uploading the updated set of dynamic page-turning elements to a server facilitates the use of different mobile communication terminals, by which the users can browse the desired network data according to their habits, thus saving the network resources.

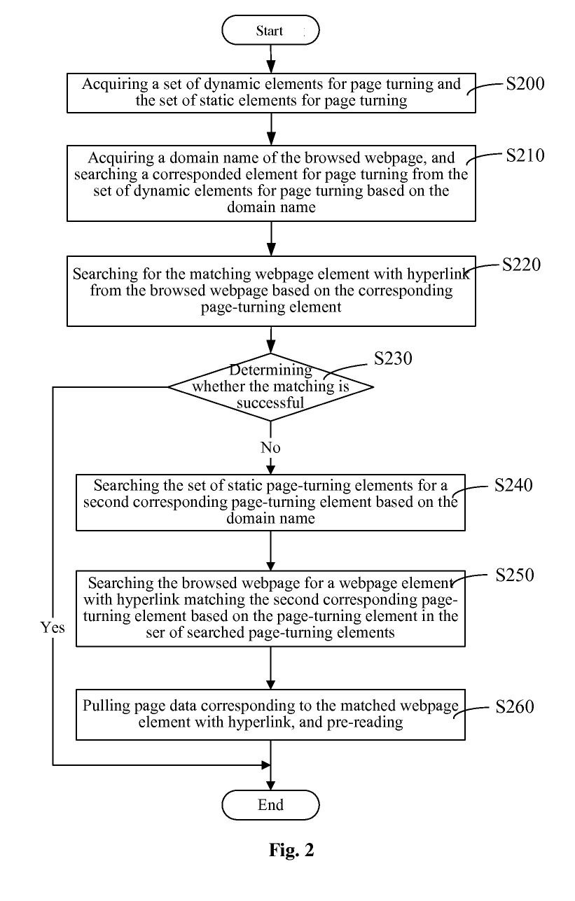

As shown in FIG. 2, a method for pre-reading network data in one embodiment comprises the steps of:

Step S200: acquiring the set of dynamic page-turning elements and the set of static page-turning elements.

There are multiple fixed page-turning elements contained in the set of static page-turning elements, such as “Next Page”, “Next One Page”, “Next Chapter”, “Next One Chapter”, etc. The priorities of the various page-turning elements can be set and recorded in the set of static page-turning elements correspondingly.

The specific step of acquiring the set of dynamic page-turning elements is: dynamically collecting the domain name of the webpage browsed by the user and the webpage element with hyperlink operated when browsing the website, and adding up to form a personal set of dynamic page-turning elements of the user. By collecting the domain name of the webpage browsed by the user and the webpage element with hyperlink operated (i.e. collecting the characteristics data of operation behaviors of the users when browsing the webpage), analyzing the collected characteristics data of operation behaviors to acquire the page-turning elements, a personal set of dynamic page-turning elements of the user is formed, which embodies the user's operation habits, thus can meet the needs of the user more accurately. In addition, the set of dynamic page-turning elements updates internal data in real time. The characteristics data of operation behaviors are the network data clicked by the user when browsing web pages. The webpage element with hyperlink refers to the node in the webpage with a point to a Web address, including text nodes, picture nodes etc., in which the text node can be expressed as “Next one page”, “Next one chapter”, etc., and the picture node can be expressed as a hand icon for page turning. After the webpage element with hyperlink is clicked, the page data of the Web address pointed by the hyperlink will be pulled.
Step S210: acquiring the domain name of the browsed webpage, and searching the set of dynamic page-turning elements for corresponding page-turning elements based on the domain name;
Step S220: searching the browsed webpage for the webpage element with hyperlink matching the page-turning element based on the page-turning element;
Step S230: determining whether the matching is successful: if yes, execute step S260; otherwise, execute step S240;
Step S240: searching the set of static page-turning elements for corresponding page-turning elements based on the domain name;
Step S250: searching the browsed webpage for the webpage element with hyperlink matching the page-turning element based on the searched set of static page-turning elements; and
Step S260: pulling the page data corresponding to the webpage element, and pre-reading.

After searching the set of static page-turning elements for the corresponding page-turning elements, the matched webpage element with hyperlink in the browsed webpage is searched based on descending order of the priorities of the page-turning elements, with page-turning elements having higher priority matching first. After matching the webpage element, the corresponding webpage data is pulled based on the address pointed to by the hyperlink of the webpage element and pre-read.

In addition, the invention also provides one or more computer storage mediums including computer-executable instructions. The computer-executable instructions are configured to execute a method for pre-reading network data. The specific steps of the method for pre-reading network data executed by computer-executable instructions in computer storage mediums are the same as the above description.

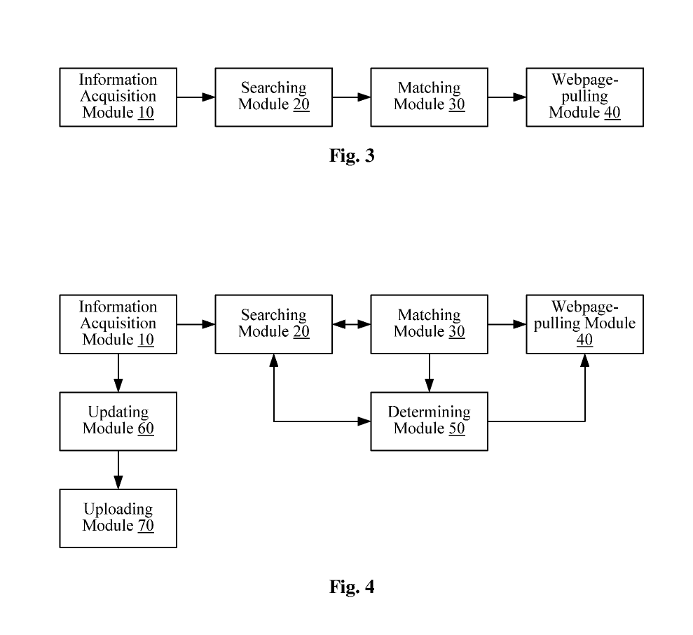

In one embodiment, as shown in FIG. 3, a system for pre-reading network data includes an information acquisition module 10, a searching module 20, a matching module 30, and a webpage-pulling module 40.

The information acquisition module 10 is configured to acquire the set of dynamic page-turning elements. The set of dynamic page-turning elements includes domain names, the page-turning elements corresponding to the domain names, etc. The page-turning element is the keyword for page turning, such as “Next page”, “Next chapter”, “Next”, and pictures and so on. The data of the set of dynamic page-turning elements when initializing can be null; as the users continue browsing different web pages, the client collects corresponding page-turning elements clicked by the user to dynamically update the data of the set of dynamic page-turning elements, and upload the data to the server, keeping the set of dynamic page-turning elements of the client the same with that of the server.

The specific process of acquiring the set of dynamic page-turning elements by the information acquisition module 10 is: dynamically collecting the domain name of the webpage browsed by the user and the webpage element with hyperlink operated when browsing the website, and adding up to form a set of dynamic page-turning elements of the user. Collecting the domain name of the webpage browsed by the user and the webpage element with hyperlink operated when browsing the website refers to collecting the characteristics data of user's operation behaviors when browsing the webpage, and acquiring the page-turning elements by analyzing the collected characteristics data of operation behaviors, which form a set of dynamic page-turning elements of the user. The set of dynamic page-turning elements of the user embodies the user operation habits, and can meet the needs of the user more accurately. In addition, the set of dynamic page-turning elements updates internal data in real time. The characteristics data of operation behaviors refers to network data clicked by the user when browsing web pages. The webpage element with hyperlink refers to the node in the webpage with a point to a Web address, including text nodes, picture nodes etc., in which the text node can be expressed as “Next page”, “Next chapter”, etc., and the picture node can be expressed as a hand icon for page turning. After the webpage element with hyperlink is clicked, the page data of the Web address pointed by the hyperlink is pulled.

In the embodiment, the information acquisition module 10 acquires the user identification number and downloads the set of dynamic page-turning elements from the server based on the user identification number. The corresponding set of dynamic page-turning elements can be saved in a server with user identification number as an index, and the saved sets of dynamic page-turning elements for different users will be different, which can meet the needs of different users.

The searching module 20 is configured to acquire the domain name of the browsed webpage, and search the set of dynamic page-turning elements for corresponding page-turning element based on the domain name. Because the set of dynamic page-turning elements contain the domain names and the page-turning elements corresponding to the domain names, it is possible to search for the page-turning elements corresponding to the domain name based on the domain name of webpage. The page-turning elements can be “Next Page”, “Next Chapter”, “Next”, and picture, etc.

The matching module 30 is configured to search the browsed webpage for the webpage element with hyperlink matching the page-turning element based on the page-turning element.

The webpage-pulling module 40 is configured to pull the page data corresponding to the webpage element, and to pre-read. Webpage elements correspond to the link addresses of URL (Universal Resource Locator). After the current page has been pulled, analyzed, rendered and typeset, the background processing program in the client is started to pull the URL page data corresponding to the webpage element. The pre-reading operation refers to pre-reading webpage data of the next page pulled in the pulling operation, and analyzing, rendering and typesetting, before the user clicks to browse the next page. Thus, when the user is browsing the current page, the process of pulling the webpage data pointed by the webpage element matching the page-turning element happens simultaneously. When the user clicks to browse the next page, the most time-consuming network interactive link can be eliminated; in addition, the matching is based on dynamic page-turning elements, which can reduce the probability of pre-reading unnecessary network data, thus increasing utilization ratio of network resource.

In a preferred embodiment, the information acquisition module 10 is also configured to acquire the weights of the page-turning elements corresponding to the domain name in the set of dynamic page-turning elements. In one embodiment, in addition to acquiring the domain name of the browsed webpage, the method also include acquiring the weights of the page-turning elements corresponding to the domain name in the set of dynamic page-turning elements. In addition to the domain names and page-turning elements corresponding to domain names, the set of dynamic page-turning elements further includes the weights and time stamps of the page-turning elements. The page-turning elements can be expressed as “Next page”, “Next chapter”, “Next”, or can be pictures, etc. The weight of page-turning element can be the collected clicked times of the element. The time stamp is the time when the page-turning element last updates. The set of dynamic page-turning elements in one embodiment is shown in Table 1.

The matching module 30 is also configured to search the browsed webpage for the webpage element with hyperlink matching the page-turning element based on descending order of the weight values of the page-turning elements, and to acquire the webpage element with hyperlink corresponding to the page-turning element having the largest weight after the page-turning element matches the webpage element. After acquiring the weight of the dynamic page-turning elements corresponding to the domain name in the set of dynamic elements, the webpage is searched for the webpage element with hyperlink to match, based on descending order of the weight values, with page-turning element having larger weight value to match first. As shown in Table 1, if the domain name of the webpage is pic.abc.com, then search the webpage for the webpage element with hyperlink matching the page-turning element of “Next Picture”.

The webpage-pulling module 40 is also configured to pull the page data corresponding to the webpage element after matching, and pre-reading. The matching module 30 acquires the webpage element corresponding to the page-turning element having the largest weight after the matching, then the webpage-pulling module 40 pulls the corresponding page data based on the webpage element, and pre-reads.

In one embodiment, as shown in FIG. 4, the system for pre-reading network data including an information acquisition module 10, a searching module 20, a matching module 30, and a webpage-pulling module 40, further includes a determining module 50, an updating module 60, and an uploading module 70.

The information acquisition module 10 is also configured to acquire the set of static page-turning elements. The information acquisition module 10 also acquires the set of static page-turning elements while acquiring the set of dynamic page-turning elements. There are multiple fixed page-turning elements in the set of static page-turning elements, such as “Next Page”, “Next One Page”, “Next Chapter”, “Next One Chapter”, etc. The priorities of the various page-turning elements can be set and recorded in the set of static page-turning elements correspondingly.

The determining module 50 is configured to determine whether the searched page-turning element in the set of dynamic page-turning elements successfully matches the webpage element with hyperlink after the matching module 30 searches the browsed webpage for the matching webpage element with hyperlink based on the searched page-turning elements. The webpage-pulling module 40 is also configured to pull the page data corresponding to the webpage element, and pre-reading, after the page-turning element in the set of dynamic page-turning elements matches the webpage element with hyperlink. When the page-turning element in the set of dynamic page-turning elements does not match the webpage element with hyperlink, the searching module 20 is also configured to search the set of static page-turning elements for corresponding page-turning elements based on the domain name. The matching module 30 is also configured to search the browsed webpage for the webpage element with hyperlink matching the page-turning element based on the page-turning element in the set of searched static page-turning elements. The webpage-pulling module 40 pulls the corresponding page data based on the webpage element, and pre-reads.

After searching the set of static page-turning elements for the corresponding page-turning elements, the matching module 30 searches the browsed webpage for the matched webpage element with hyperlink based on descending order of the priorities of the page-turning elements, with page-turning elements having higher priority matching first. After matching the webpage element, the corresponding webpage data is pulled based on the address pointed by the hyperlink of the webpage element and pre-read.

The information acquisition module 10 is also configured to acquire the webpage element with hyperlink which is clicked by the user, and then the updating module 60 updates the set of dynamic page-turning elements by adding the webpage element with hyperlink clicked by the user.

In the embodiment, the updating module 60 is also configured to search the set of dynamic page-turning elements for the list of page-turning elements corresponding to the domain name based on the domain name of the webpage which has the webpage element with hyperlink clicked by the user, and determining whether the webpage element with hyperlink clicked by the user is in the list of page-turning elements: if yes, adding 1 to the weight of the page-turning element; otherwise, adding the webpage element with hyperlink to the list of page-turning elements. If the webpage element clicked by the user is in the list of page-turning elements, then add 1 to the weight of the page-turning element, for example, the webpage element of “Next Picture” can be found in Table 1, then the weight of the page-turning element of “Next Picture” is added by 1 and reaches 9. If the webpage element clicked by the user is not in the list of page-turning elements, then the webpage element is added to the list of page-turning elements, and its weight set to be 1; for example, the page-turning element of “Next” is added to Table 1, with its weight set to be 1. In this way the set of dynamic page-turning elements is updated.

The uploading module 70 uploads the user identification number and the updated set of dynamic page-turning elements to a server. The uploading module 70 uploads the updated set of dynamic page-turning elements to a server, allowing the users to browse their desired network data according to their habits when using different mobile communication terminals, thus saving the network resources.

By the above described method, system and computer storage medium for pre-reading network data, the set of dynamic page-turning elements is used to acquire the domain name of the browsed webpage, to search corresponding page-turning elements from the set of dynamic page-turning elements, then to search matched webpage element with hyperlink from the browsed webpage based on the page-turning element and to pull the page data corresponding to the webpage element to pre-read. The set of dynamic page-turning elements includes the page-turning element required by users, therefore, pre-reading based on said page-turning element can improve the accuracy of the pre-read content, reduce the probability of sending unnecessary network data for a user to the user, and increase utilization ratio of network resource.

In addition, matching the page-turning element and the webpage element based on descending order of the weight values of the page-turning elements improves the matching efficiency and meets the needs of users as much as possible, which further reduces the probability of sending unnecessary network data to the user, increases the utilization ratio of network resource; by combining the set of dynamic page-turning elements with the set of static page-turning elements, the needs of users can be better met, increasing the utilization ratio of network resource; by acquiring the webpage element with hyperlink clicked by the user, the set of dynamic page-turning elements is updated, which further provides the accuracy of matching the needs of users; by uploading the updated set of dynamic page-turning elements to a server, the method facilitates the use of different mobile communication terminals, meeting the users' needs and utilizing the network resources despite of the mobile communication terminals used.

The above embodiments described are only several embodiments of the present invention, and they should not be understood as a limitation on the scope of the present invention. It should be noted that the modifications and variations could be made by the skilled in the art, which will be within the protection scope of the present invention. The protection scope of this invention is defined by the appending claims.

What is claimed is:

1. A method for pre-reading network data, comprising the steps of:
acquiring a set of dynamic page-turning elements;
acquiring a domain name of a browsed webpage, and searching the set of dynamic page-turning elements for a corresponding page-turning element based on the domain name;
searching the browsed webpage for a webpage element with hyperlink matching the corresponding page-turning element based on the corresponding page-turning element; and
pulling page data corresponding to the matched webpage element, and pre-reading.

2. The method for pre-reading network data of claim 1, wherein the method further comprises the step of acquiring a set of static page-turning elements, and
after the step of searching for the matching webpage element with hyperlink from the browsed webpage based on the corresponding page-turning element:
determining whether the matching is successful: if yes, pulling page data corresponding to the matched webpage element after matching, and pre-reading; otherwise, searching the set of static page-turning elements for a second corresponding page-turning element based on the domain name, and searching the browsed webpage for a webpage element with hyperlink matching the second corresponding page-turning element based on the page-turning element in the set of searched static page-turning elements, then pulling page data corresponding to the matched webpage element with hyperlink, and pre-reading.

3. The method for pre-reading network data of claim 1, wherein the method further comprises the steps of:
acquiring weights of the page-turning elements corresponding to the domain name in the set of dynamic page-turning elements; and
searching the browsed webpage for the webpage element with hyperlink matching the page-turning element based on descending order of the weight values of the page-turning elements, and identifying the webpage element with hyperlink corresponding to the page-turning element having the largest weight after the page-turning element matches the webpage element.

4. The method for pre-reading network data of claim 3, wherein the method further comprises the step of: acquiring a webpage element with hyperlink which is clicked by a user, and updating the set of dynamic page-turning elements by adding the webpage element with hyperlink clicked by the user.

5. The method for pre-reading network data of claim 4, wherein the step of updating the set of dynamic page-turning elements by adding the webpage element with hyperlink clicked by the user comprises:
searching the set of dynamic page-turning elements for a list of page-turning elements corresponding to the domain name based on the domain name of the webpage which has the webpage element with hyperlink clicked by the user; and
determining whether the webpage element with hyperlink clicked by the user is in the list of page-turning elements: if yes, adding 1 to the weight of the page-turning element; otherwise, adding the webpage element with hyperlink to the list of page-turning elements.

6. The method for pre-reading network data of claim 4, wherein the method further comprises: uploading a user identification number and the updated set of dynamic page-turning elements to a server; and acquiring the user identification number, and downloading the set of dynamic page-turning elements from the server based on the user identification number.

7. The method for pre-reading network data of claim 1, wherein the step of acquiring the set of dynamic page-turning elements comprises: dynamically collecting the domain name of the webpage browsed by a user and webpage elements with hyperlink operated when browsing the webpage, and adding up the webpage elements to form a set of dynamic page-turning elements of the user.

8. A system for pre-reading network data, comprising:
an information acquisition module, configured to acquire a set of dynamic page-turning elements;
a searching module, configured to acquire a domain name of a browsed webpage, and to search the set of dynamic page-turning elements for a corresponding page-turning element based on the domain name;
a matching module, configured to search the browsed webpage for a webpage element with hyperlink matching the corresponding page-turning element based on the corresponding page-turning element; and
a webpage-pulling module, configured to pull page data corresponding to the matching webpage element, and to pre-read.

9. The system for pre-reading network data of claim 8, wherein the information acquisition module is also configured to acquire a set of static page-turning elements, and
the system for pre-reading network data further comprises:
a determining module, configured to determine whether the corresponding page-turning element in the set of dynamic page-turning elements matches the webpage element with hyperlink;
wherein the webpage-pulling module is also configured to pull page data corresponding to the matching webpage element, and to pre-read, after the page-turning element in the set of dynamic page-turning elements matches the webpage element with hyperlink,
wherein the searching module is also configured to search the set of static page-turning elements for a second corresponding page-turning element based on the domain name, when the page-turning elements in the set of dynamic page-turning elements do not match the webpage element with hyperlink, and
wherein the matching module is also configured to search the browsed webpage for a webpage element with hyperlink matching the second corresponding page-turning element based on the second corresponding page-turning element in the set of searched static page-turning elements.

10. The system for pre-reading network data of claim 8, wherein the information acquisition module is also configured to acquire weights of the page-turning elements corresponding to the domain name in the set of dynamic page-turning elements, and
wherein the matching module is configured to search the browsed webpage for the webpage element with hyperlink matching the page-turning element based on descending order of the weight values of the page-turning elements, and to identify the webpage element with hyperlink corresponding to the page-turning element having the largest weight after the page-turning element matches the webpage element.

11. The system for pre-reading network data of claim 10, wherein the information acquisition module is also configured to acquire a webpage element with hyperlink which is clicked by a user, and
the system further comprises:
an updating module, configured to update the set of dynamic page-turning elements by adding the webpage element with hyperlink clicked by the user.

12. The system for pre-reading network data of claim 11, wherein the updating module is also configured to search the webpage which has the webpage element with hyperlink clicked by the user for the list of page-turning elements corresponding to the domain name based on the domain name of, and to determine whether the webpage element with hyperlink clicked by the user is in the list of page-turning elements: if yes, adding 1 to the weight of the page-turning element; otherwise, adding the webpage element with hyperlink to the list of page-turning elements.

13. The system for pre-reading network data of claim 11, wherein the system further comprises an uploading module for uploading a user identification number and the updated set of dynamic page-turning elements to a server, and wherein the information acquisition module is also configured to acquire the user identification number, and downloading the set of dynamic page-turning elements from the server based on the user identification number.

14. The system for pre-reading network data of claim 8, wherein the information acquisition module is also configured to dynamically collect the domain name of the webpage browsed by a user and webpage elements with hyperlink operated when browsing the webpage, and adding up the webpage elements to form a set of dynamic page-turning elements of the user.

15. A non-transitory computer-readable storage medium with computer-executable instructions which, when executed by one or more computer processors, causes the one or more computer processors to pre-read network data, wherein the computer-executable instructions comprise instructions for:
acquiring a set of dynamic page-turning elements;
acquiring a domain name of a browsed webpage, and searching the set of dynamic page-turning elements for a corresponding page-turning element based on the domain name;
searching the browsed webpage for a webpage element with hyperlink matching the corresponding page-turning element based on the corresponding page-turning element; and
pulling page data corresponding to the matched webpage element, and pre-reading.

16. The computer storage medium of claim 15, wherein the computer-executable instructions further comprises instructions for acquiring a set of static page-turning elements, and
after the step of searching the browsed webpage for a matching webpage element with hyperlink based on the corresponding page-turning element:
determining whether the matching is successful: if yes, pulling page data corresponding to the matched webpage element with hyperlink after matching, and pre-reading; otherwise, searching the set of static page-turning elements for a second corresponding page-turning element based on the domain name, and searching the browsed webpage for a webpage element with hyperlink matching the second corresponding page-turning element based on the page-turning element in the set of searched static page-turning elements, then pulling page data corresponding to the matched webpage element with hyperlink, and pre-reading.

17. The computer storage medium of claim 15, wherein the computer-executable instructions further comprises instructions for:
acquiring weights of the page-turning elements corresponding to the domain name in the set of dynamic page-turning elements; and
searching the browsed webpage for the webpage element with hyperlink matching the page-turning element based on descending order of the weight values of the page-turning elements, and identifying the webpage element with hyperlink corresponding to the page-turning element having the largest weight after the page-turning element matches the webpage element.

18. The computer storage medium of claim 17, wherein the computer-executable instructions further comprises instructions for: acquiring a webpage element with hyperlink which is clicked by a user, and updating the set of dynamic page-turning elements by adding the webpage element with hyperlink clicked by the user.

19. The computer storage medium of claim 18, wherein the instructions for updating the set of dynamic page-turning elements by adding the webpage element with hyperlink clicked by the user comprises instructions for:
searching the webpage which has the webpage element with hyperlink clicked by the user for the list of page-turning elements corresponding to the domain name based on the domain name; and
determining whether the webpage element with hyperlink clicked by the user is in the list of page-turning elements: if yes, adding 1 to the weight of the page-turning element; otherwise, adding the webpage element with hyperlink to the list of page-turning elements.

20. The computer storage medium of claim 15, wherein the instructions for acquiring the set of dynamic page-turning elements comprises instructions for: dynamically collecting the domain name of a webpage browsed by a user and webpage elements with hyperlink operated when browsing the webpage, and adding up the webpage elements to form a set of dynamic page-turning elements of the user.
